(19) United States
(12) Patent Application Publication
(10) Pub. No.: US 2002/0076594 A1
(43) Pub. Date: Jun. 20, 2002

(54) Active solid polymer electrolyte membrane for solid polymer electrolyte fuel cell

(76) Inventors: Kaoru Fukuda, Saitama (JP); Nobuhiro Saito, Saitama (JP); Kazuhide Terada, Saitama (JP)

Correspondence Address: ARENT FOX KINTNER PLOTKIN & KAHN, PLLC, Suite 400, 1050 Connecticut Avenue, N.W., Washington, DC, 20036-5339, US

(21) Appl. No.: 09/970,659

(22) Filed: Oct. 5, 2001

(30) Foreign Application Priority Data
Oct. 12, 2000 (JP) 2000-311902

(51) Int. Cl. H01M 8/10; H01M 4/86; H01M 4/88; B05D 5/12

(52) U.S. Cl. 429/30; 429/40; 502/101; 427/115

(57) ABSTRACT

An active solid polymer electrolyte membrane provides an enhancement in power-generating performance. The active solid polymer electrolyte membrane in a solid polymer electrolyte fuel cell includes a solid polymer electrolyte element, and a plurality of noble metal catalyst grains which are carried by an ion exchange in a surface layer located inside a surface of the solid polymer electrolyte element and which are dispersed uniformly in the entire surface layer. The surface layer has a thickness t₂ equal to or smaller than 10 μm. An amount CA of noble metal catalyst grains carried is in a range of 0.02 mg/cm²≦CA<0.14 mg/cm².

### BACKGROUND OF THE INVENTION

1. Field of the Invention

The present invention relates to an active solid polymer electrolyte membrane for a solid polymer electrolyte fuel cell.

2. Description of the Related Art

There is a conventionally known active solid polymer electrolyte membrane having a noble metal catalyst carried on a surface thereof by a sputtering process.

However, the conventional noble metal catalyst is formed into a layered shape and for this reason, the transmission of produced hydrogen ions to the solid polymer electrolyte membrane and the transmission of such hydrogen from the electrolyte membrane to an air electrode are relatively low, and an interface where the noble metal catalyst, the solid polymer electrolyte membrane and a fuel gas are brought into contact with one another, namely, a three-phase interface is small. Therefore, there is a problem that the power-generating performance is low, notwithstanding that the amount of noble metal carried in the electrolyte membrane is large.

The present inventors have developed an active solid polymer electrolyte membrane which ensures that the power-generating performance of a fuel cell made with a small amount of a noble metal carried can be enhanced, and which comprises a solid polymer electrolyte membrane element and a plurality of noble metal catalyst grains carried by an ion exchange in a surface layer existing inside a surface of the solid polymer electrolyte membrane element, the surface layer having a thickness t₂ equal to or smaller than 10 μm, and an amount CA of noble metal catalyst grains carried being in a range of 0.14 mg/cm²≦CA≦0.35 mg/cm² (see the specification and the drawings of Japanese Patent Application No.11-174640).

If the active solid polymer electrolyte membrane is formed into the above-described configuration, the noble metal catalyst grains are interspersed in the surface layer of the solid polymer electrolyte membrane element. Therefore, the transmission of produced hydrogen ions to the solid polymer electrolyte membrane and the transmission of produced hydrogen ions from the solid polymer electrolyte membrane to the air electrode are enhanced, and the association of the hydrogen ions and oxygen is improved. Moreover, there are many three-phase interfaces where the noble metal catalyst grains, the solid polymer electrolyte membrane element and a fuel gas are in contact with one another. Thus, it is possible to reduce the amount of noble metal carried in the solid polymer electrolyte membrane element and moreover to enhance the power-generating performance of the fuel cell.

The noble metal catalyst is used not only in a fuel cell, but also, for example, often in engine exhaust emission control. It is conventionally believed that the smaller the amount of noble metal used, the more preferable for the purpose of preventing noble metals from being drained.

### SUMMARY OF THE INVENTION

It is an object of the present invention to provide a active solid polymer electrolyte membrane of the above-described type, wherein the amount of noble metal carried is reduced to smaller than that in the above-described conventional art and nevertheless, the power-generating performance of a fuel cell can be enhanced.

To achieve the above object, according to the present invention, there is provided an active solid polymer electrolyte membrane for a solid polymer electrolyte fuel cell, including a solid polymer electrolyte element, and a plurality of noble metal catalyst grains which are carried by an ion exchange in a surface layer located inside a surface of the solid polymer electrolyte element and which are dispersed uniformly in the entire surface layer, the surface layer having a thickness t₂ equal to or smaller than 10 μm, wherein an amount CA of the noble metal catalyst grains carried is in a range of 0.02 mg/cm²≦CA<0.14 mg/cm².

If the amount CA of noble metal catalyst grains carried is set at a level as small as CA<0.14 mg/cm², the dispersion of the noble metal catalyst grains in the surface layer of the electrolyte membrane element is enhanced, as compared with the conventional art in which the amount CA of noble metal catalyst grains carried is equal to or larger than 0.14 mg/cm². Thus, the transmission of produced hydrogen ions to the solid polymer electrolyte membrane and the transmission of produced hydrogen ions from the solid polymer electrolyte membrane to an air electrode are enhanced more than those in the conventional art, and the association of the hydrogen ions and oxygen is also improved. Further, there are a larger number of three-phase interfaces where the noble metal catalyst grains, the solid polymer electrolyte membrane element and a fuel gas are in contact with one another and hence, the power-generating performance of the fuel cell can be further enhanced. However, if the amount CA of noble metal catalyst grains carried is smaller than 0.02 mg/cm², the effectiveness of the use of the noble metal catalyst grains is lost.

### BRIEF DESCRIPTION OF DRAWINGS

FIG. 1 is a diagrammatic side view of a solid polymer electrolyte fuel cell in accordance

FIG. 2 is a diagrammatic sectional view of an active solid polymer electrolyte membrane, taken along a line 2-2 in FIG. 1; and

FIG. 3 is a graph showing the relationship between the current density and the terminal voltage in each of solid polymer electrolyte fuel cells.

### DETAILED DESCRIPTION OF THE PREFERRED EMBODIMENTS

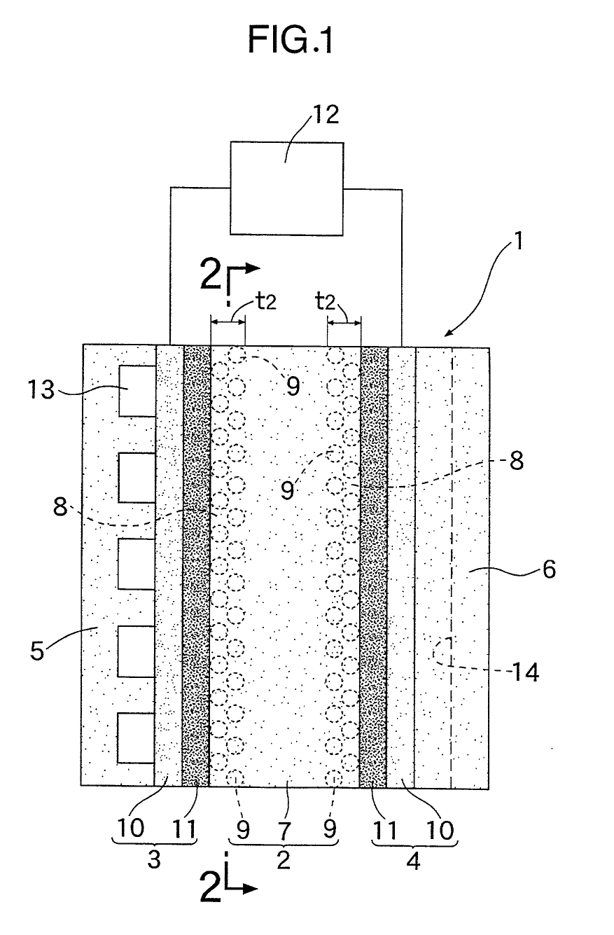

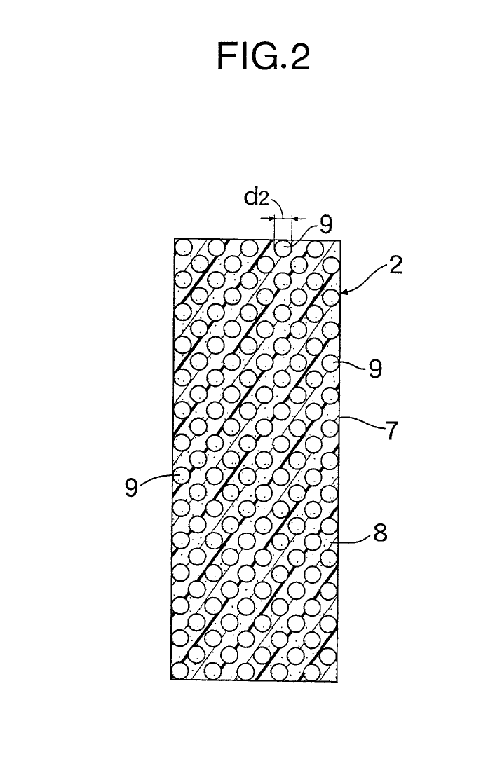

Referring to FIGS. 1 and 2, a solid polymer electrolyte fuel cell 1 comprises an active solid polymer electrolyte membrane (which will be referred to as an active electrolyte membrane hereinafter) 2, an air electrode 3 and a fuel electrode 4 provided in close contact with opposite surfaces of the active electrolyte membrane 2, respectively, and a pair of separators 5 and 6 provided in close contact with the electrodes 3 and 4, respectively.

The active electrolyte membrane 2 is comprised of a solid polymer electrolyte element (which will be referred to as an electrolyte membrane element hereinafter) 7 having a thickness t₁ in a range of 5 μm≦t₁≦200 μm, and a plurality of noble metal catalyst grains 9 which are carried by an ion exchange in a surface layer 8 located inside a surface of the electrolyte membrane element 7 and which are dispersed uniformly in the entire surface layer 8. An amount CA of noble metal catalyst grains carried is in a range of 0.02 mg/cm²≦CA≦0.14 mg/cm². The surface layer 8 has a thickness t₂ equal to or smaller than 10 μm (t₂≦10 μm). Each of the noble metal catalyst grains 9 is a secondary grain resulting from the bonding and agglomeration of primary grains having a crystallite diameter d₁ equal to or smaller than 5 nm as measured by an X-ray diffraction. The secondary grain has a grain size in a range of 5 nm≦d₂≦200 nm. The electrolyte membrane element 7 which may be used is a fluorine resin-based ion-exchange membrane, for example, Flemion (a trade name) made by Asahi Glass, Co., Nafion (a trade name) made by du Pont de Nemours, E.I., and Co., and the like. The noble metal catalyst grains 9, for example, correspond to Pt grains.

Each of the air electrode 3 and the fuel electrode 4 comprises a porous carbon plate 10 and an auxiliary catalyst layer 11 applied to and formed on one surface of the porous carbon plate 10. The auxiliary catalyst layers 11 are in close contact with opposite sides of the electrolyte membrane element 7, respectively. Each of the auxiliary catalyst layers 11 comprises Pt grains carried on surfaces of carbon black grains, and a fluorine resin-based ion-exchanger (under a trade name of Flemion) which is a polymer electrolyte. The porous carbon plates 10 of the electrodes 3 and 4 are connected to a load 12, e.g., a DC motor device for a vehicle.

The separators 5 and 6 are formed of graphitized carbon to have the same shape. Air is supplied to a plurality of grooves 13 located in the separator 5 on the side of the air electrode 3, and hydrogen is supplied to a plurality of grooves 14 located on the separator 6 on the side of the fuel electrode 4 in an intersecting relation to the grooves 13.

To produce the active electrolyte membrane 2, the following steps are conducted sequentially: a step of immersing an electrolyte membrane element 7 into a mixture of a noble metal complex solution and at least one additive selected from a water-soluble organic solvent, a nonionic surfactant and a non-metallic base to conduct an ion-exchanging, a step of washing the electrolyte membrane element 7 with pure water, a step of subjecting the electrolyte membrane element 7 to a reducing treatment, a step of washing the electrolyte membrane element 7 with pure water, and a step of drying the electrolyte membrane element 7.

An example of the noble metal complex solution, which may be used, is a cationic Pt complex solution containing Pt complex ions, [Pt(NH₃)₄]²⁺. In the additive, examples of the water-soluble organic solvent, which may be used, are methanol, ethanol, ethylene glycol and the like, and examples of the nonionic surfactant which may be used are polyoxyethylene decyl ether (e.g., Briji 35 which is a trade name), poly oxyethylene octylphenyl ether and the like. Further, examples of the non-metallic base, which may be used, are ammonia and the like.

When the ion-exchange is carried out under the action of the additive, the Pt complex ions are adsorbed to a plurality of ion-exchange points located in the surface layer 8 of the electrolyte membrane element 7 and dispersed uniformly in the entire surface layer 8. At the first washing step, free Pt complex ions and the additive present in the electrolyte membrane element 7 are removed. At the reducing step, a group of atoms bonded to Pt atoms in the Pt complex ions are removed. At the second washing step, a reducing component is removed from the electrolyte membrane element 7, and thus, the active electrolyte membrane 2 is produced through the subsequent drying step.

If the reducing treatment is carried out without conduction of the first washing, Pt atoms are left to remain in free states in the electrolyte membrane element 7. However, such Pt atoms do not contribute to the generation of hydrogen ions and hence, expensive platinum (Pt) is useless. If the second washing is not carried out, the ionization of hydrogen is obstructed by the remaining of the reducing component, resulting in a reduced power-generating performance.

Particular examples are described below.

Example 1 of an active electrolyte membrane 2 was produced through the following steps (a) to (f):

(a) An amount of ammonia water equal to 250 cc was added as an additive to a cationic Pt complex solution containing an amount of platinum (Pt) equivalent to an intended amount (0.02 mg/cm²) of platinum (Pt) carried, thereby preparing a liquid mixture.

(b) To conduct the ion exchange, an electrolyte membrane element (Flemion which is a trade name) 7 having a size of 70 mm×70 mm was immersed into the liquid mixture and then, the resulting mixture was heated to 60° and agitated for 12 hours at such temperature.

(c) To conduct the washing, the electrolyte membrane element 7 was immersed into pure water, and the resulting pure water was heated to 50° and agitated for 2 hours at such temperature.

(d) To conduct the reducing treatment, the water used for the washing was removed from a container having the electrolyte membrane element 7 placed therein, and new pure water was added to the container, whereby the electrolyte membrane element 7 was immersed into such pure water. A reducing liquid mixture of a mole ten times the intended amount of Pt carried, i.e., a liquid mixture containing boron sodium hydride and sodium carbonate was also prepared. Then, the pure water containing the electrolyte membrane element 7 immersed therein was heated to 50° C., and the entire amount of the reducing liquid mixture was dropped over 30 minutes into the pure water maintained at such temperature. Thereafter, the resulting mixture was left to stand for about 1.5 hours, and the time point when the generation of a gas (mainly hydrogen) out of the solution was stopped was regarded as a reaction-finished point.

(e) To conduct the washing for removing the Na component, the electrolyte membrane element 7 was immersed into pure water and then, the resulting pure water was heated to 50° C. and agitated for 2 hours at such temperature.

(f) The electrolyte membrane element 7 was retained for 4 hours in a dryer having a temperature of 60° C. and thus dried.

Example 2 of an active electrolyte membrane 2 was produced under the same conditions as in Example 1, except that the intended amount of Pt carried was set at 0.03 Mg/cm².]

Example 3 of an active electrolyte membrane 2 was produced under the same conditions as in Example 1, except that the intended amount of Pt carried was set at 0.06

Example 4 of an active electrolyte membrane 2 was produced under the same conditions as in Example 1, except that the intended amount of Pt carried was set at 0.13 mg/cm².

Comparative Example of an active electrolyte membrane 2 was produced under the same conditions as in Example 1, except that the intended amount of Pt carried was set at 0.14 mg/cm².

Table 1 shows the configuration of each of Examples 1 to 4 and Comparative Example of the active electrolyte membrane 2.

TABLE 1

| | Active electrolyte membrane | | | | |
|---|---|---|---|---|---|
| | Example | | | | Comparative |
| | 1 | 2 | 3 | 4 | Example |
| Pt grains | | | | | |
| Amount of Pt | 0.02 | 0.03 | 0.06 | 0.13 | 0.14 |
| carried (mg/cm²) | | | | | |
| Crystallite diameter | 1.2 | 1.6 | 1.8 | 2.0 | 2.0 |
| d₁ (nm) | | | | | |
| Grain size d₂ (nm) | 5 to 10 | 5 to 10 | 5 to 10 | 8 to 15 | 10 to 20 |
| Thickness t₂ of | 2.5 | 2.5 | 3.0 | 3.0 | 4.5 |
| surface layer (μm) | | | | | |

Each of an air electrode 3 and a fuel electrode 4 was fabricated by a process comprising the step of applying a mixture of Pt grains carried on surfaces of carbon black grains and a fluorine resin-based ion-exchanger (under a trade name of Flemion) as a polymer electrolyte onto one surface of a porous carbon plate 10 to form an auxiliary catalyst layer 11. In this case, the weight ratio of the carbon black grains to the Pt grains is 1:1.

Table 2 shows a configuration of the auxiliary catalyst layer 11. In Table 2, character C means the carbon grains, and character PE means the polymer electrolyte.

TABLE 2
Auxiliary catalyst layer

| | | |
|---|---|---|
| Pt grains | Amount of Pt carried (mg/cm²) | 0.3 |
| | Crystallite diameter (nm) | 2.4 |

| | |
|---|---|
| Amount of C carried (mg/cm²) | 0.3 |
| Amount of PE carried (mg/cm²) | 0.45 |
| Thickness (μm) | 20 |

A fuel cell 1 was assembled using the active electrolyte membrane 2, the air electrode 3, the fuel electrode 4 and the like in each of Examples and Comparative Example and then operated to examine the relationship between the current density and the terminal voltage, thereby providing results shown in Table 3. Examples 1 to 4 and Comparative Example in Table 3 mean the fuel cell made using Examples 1 to 4 and Comparative Example of the active electrolyte membranes 2 shown in Table 1.

TABLE 3

| Current | Terminal voltage (V) | | | | |
|---|---|---|---|---|---|
| density | | | | | Comparative |
| (A/cm²) | Example 1 | Example 2 | Example 3 | Example 4 | Example |
| 0 | 1.03 | 1.03 | 1.03 | 1.02 | 0.98 |
| 0.1 | 0.84 | 0.85 | 0.83 | 0.82 | 0.79 |
| 0.2 | 0.81 | 0.81 | 0.79 | 0.80 | 0.73 |
| 0.4 | 0.75 | 0.76 | 0.74 | 0.73 | 0.66 |
| 0.6 | 0.70 | 0.71 | 0.69 | 0.68 | 0.62 |
| 0.8 | 0.63 | 0.66 | 0.63 | 0.62 | 0.57 |
| 1.0 | 0.56 | 0.57 | 0.56 | 0.54 | 0.51 |
| 1.2 | 0.44 | 0.46 | 0.45 | 0.44 | 0.43 |

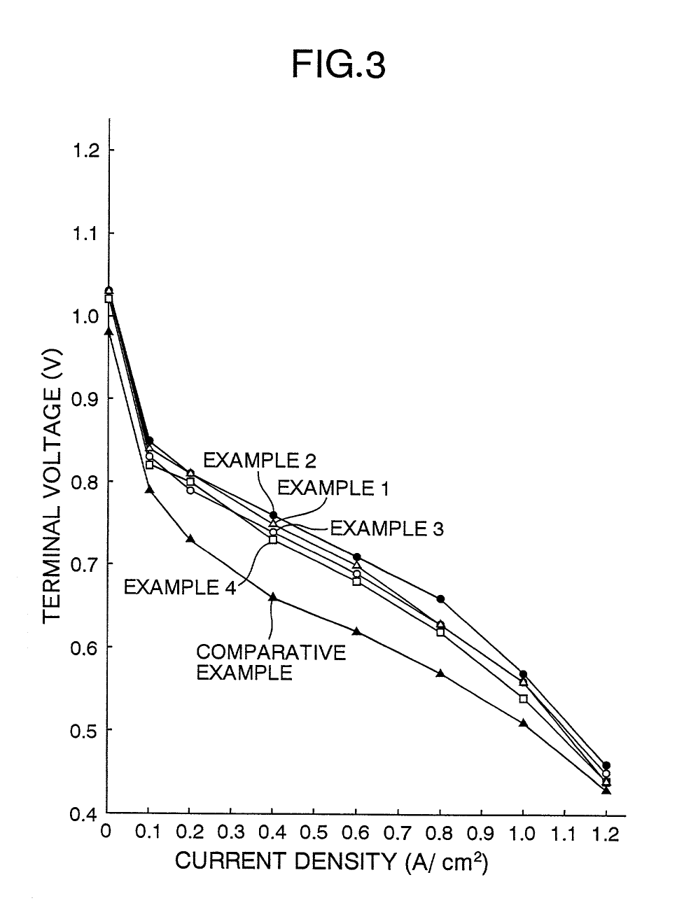

FIG. 3 is a graph made based on Table 3 and showing the relationship between the current density and the terminal voltage for the fuel cells made using Examples 1 to 4 and Comparative Example shown in Table 3. It can be seen from FIG. 3 that when Examples 1 to 4 with the amount of Pt grains carried set at the values described above were used, the power-generating performance was enhanced, as compared with that provided when Comparative Example with the amount of Pt grains carried larger than those in Examples was used.

According to the present invention, it is possible to provide an active solid polymer electrolyte membrane which ensures that the power-generating performance of a solid polymer electrolyte fuel cell can be enhanced by forming such solid polymer electrolyte membrane into the above-described configuration.

What is claimed is:

1. An active solid polymer electrolyte membrane for a solid polymer electrolyte fuel cell, comprising a solid polymer electrolyte element, and a plurality of noble metal catalyst grains which are carried by an ion exchange in a surface layer located inside a surface of said solid polymer electrolyte element and which are dispersed uniformly in the entire surface layer, said surface layer having a thickness t₂ equal to or smaller than 10 μm, wherein an amount CA of the noble metal catalyst grains carried is in a range of 0.02 mg/cm²≦CA<0.14 mg/cm².

2. The active solid polymer electrolyte membrane of claim 1 wherein said range is 0.02 mg/cm²≦CA≦0.13 mg/cm².

3. A process for producing the active solid polymer electrolyte membrane of claim 1 comprising:
immersing an electrolyte membrane element into a mixture of a noble metal complex solution and at least one additive selected from a water-soluble organic solvent, a nonionic surfactant and a non-metallic base to conduct an ion-exchanging;
washing the electrolyte membrane element with pure water;
subjecting the electrolyte membrane element to a reducing treatment;
washing the electrolyte membrane element with pure water; and
drying the electrolyte membrane element.
